(19) United States
(12) Patent Application Publication
(10) Pub. No.: US 2011/0154984 A1
(43) Pub. Date: Jun. 30, 2011

(54) Piston for an Internal-Combustion Engine and Method for Manufacturing a Piston of this Type

(75) Inventors: Mauro Aparecido Ferreira De Oliveira, Sao Paulo (BR); Heraldo Carlos Furquim, Sao Paulo (BR); Joao Lester Garcia Lopes, Sao Paulo (BR)

(73) Assignee: ThyssenKrupp Metalurgica Campo Limpo Ltda., Campo Limpo Paulista, SP (BR)

(21) Appl. No.: 12/674,869

(22) PCT Filed: Aug. 22, 2008
(86) PCT No.: PCT/IB08/02190

§ 371 Date: Mar. 14, 2011

(30) Foreign Application Priority Data
Aug. 24, 2007 (EP) EP07114934.8

(51) Int. Cl. F16J 1/00; B23P 11/02

(52) U.S. Cl. 92/172; 29/447

(57) ABSTRACT

A piston for an internal-combustion engine is made up of a first part and a second part. One of the two parts forms the piston head and the other part forms the piston skirt. A cooling chamber, which is delimited by material of the first part and by material of the second part, is configured in the piston. The two parts are joined together positively and non-positively via a press fit formed by a projection of the second part, with the projection engaging with a recess in the first part.

### BACKGROUND AND SUMMARY OF THE INVENTION

This application is a national stage of PCT International Application No. PCT/IB2008/002190, filed Aug. 22, 2008, which claims priority under 35 U.S.C. §119 to European Patent Application No. 07114934.8, filed Aug. 24, 2007, the entire disclosure of which is herein expressly incorporated by reference.

The present invention relates to a piston for an internal-combustion engine. The piston has a cooling chamber, and is made up of two pre-produced parts. The invention also provides a method for manufacturing a piston of this type.

Pistons for internal-combustion engines are conventionally manufactured by casting or forging. Production by casting has the advantage of allowing the manufacture of light pistons of complex shape. However, considerable production costs have to be allowed for. This is especially the case if steel is to be used as the material for the manufacture of particularly high-strength pistons.

Depending on their size and intended application, forged pistons made of steel can be of one-part construction, or can comprise two or more parts. In multi-part pistons (pistons composed of two or more parts), the individual parts are conventionally joined together, either non-positively, in a material-uniting manner, or positively, by suitable joining methods in such a way that they withstand the forces acting on them in practical use.

In the case of highly stressed diesel engines or highly charged spark-ignition engines, the heads of the pistons inserted therein are exposed to considerable thermal loads. In order to counteract the danger emanating from these loads, it has long been known to introduce at least one cooling chamber formed as a cooling channel into pistons of this type. The cooling channel can be connected to the atmosphere present in the crank chamber of the respective engine, so air passes through it during operation. To improve the effectiveness of such cooling, it is also known to integrate the cooling channel of a piston into the oil-circulation system of the respective internal-combustion engine.

One example of a large number of pistons of this type, described in European patent document EP 0 787 898 A1, is composed of a piston head part and a piston skirt part. The piston skirt part includes an intermediate part, which forms the bearing for the bolt of the connecting rod to be linked to the piston, and an outer part forming the piston skirt itself.

In the known piston, there is formed into the underside of the piston head part, associated with the piston skirt part, a recess formed in the manner of a groove and encircling in the outer edge region of the piston head part. Correspondingly, a recess, also in the form of a groove and encircling in the outer edge region of the piston skirt part, is formed in the upper side of the piston skirt part, associated with the piston head part. When the piston is fully assembled, the two recesses jointly form a closed, peripheral cooling channel which is delimited in its upper region by material of the piston head part and in its lower region by material of the piston skirt part. The cooling channel thus formed is in this case connected to the bearing, formed integrally with the piston skirt part, for the connecting rod via a hole guided through the piston skirt part. Thus, during operation, the oil conveyed to the bearing of the connecting rod can flow into the cooling channel and discharge the heat present therein.

In the above-described known piston, the piston skirt and piston head parts, which are pre-produced separately from each other, are connected using a plurality of screws which are screwed from the upper side of the piston head part into the piston skirt part.

Although the multi-part construction of the known piston allows the cooling channel to be manufactured in a simple manner, the assembly of the known piston is complex. The inevitable arrangement of the screw heads of the connecting screws in the combustion cavity of the piston head part also restricts the freedom of the design of a piston of this type.

Another piston, composed of a plurality of parts, with a cooling channel is described in International patent document WO 00/04286. This known piston also consists of a piston head part and a piston skirt part. However, unlike in the piston described in European patent document EP 0 787 898 A1, the piston head part is composed of an upper part and a lower part receiving the bearing for the connecting rod bolt. The lower part additionally carries, in this case, the sleeve-like piston skirt part. Correspondingly shaped recesses are formed into the mutually associated sides of the piston head upper and lower part. When the piston is fully assembled, the recesses jointly form a cooling channel which is enclosed on its underside by material of the piston head lower part and on its upper side by material of the piston head upper part. The cooling channel can be connected to an oil supply via a hole and an opening.

In the piston known from International patent document WO 00/04286, the connection between the individual piston parts is produced by friction welding. As a result, the individual parts are permanently rigidly connected to one another in a material-uniting manner. This type of connection not only presupposes a specific configuration of the faces brought into contact with one another for welding but also restricts the choice of materials of which the piston is composed. Thus, in this known piston it is not possible to make the piston head upper part (which is in practice subjected to high loads) of a steel material and the piston head lower part (which is subjected to lower loads) from a light material in order to save weight.

A further possibility for connecting two parts of a piston for an internal-combustion engine is described in German patent document DE 103 07 908 A1. In this prior art, the piston has a piston skirt part, and the casing portion reaches up to the upper side of the piston, so the grooves for receiving the piston rings can be formed into the upper portion of the piston skirt part. At its upper end, the piston skirt part surrounds an opening into which a plate or plug-like piston head part is formed as a piston head part. The external diameter of the piston head part and the internal diameter of the opening in the piston skirt part are, in this case, mutually adapted in such a way that the piston head part is held in the opening in a press fit. At the same time, the underside of the piston head part rests on material of the piston skirt part, so the piston head part is supported against the piston skirt part counter to the drive forces acting on it during practical operation. In addition, screws ensure that the piston head part is secured in the piston skirt part.

Although the piston described in German patent document DE 103 07 908 A1 is intended for high-speed two-stroke engines, no cooling channel is provided. Instead, the load capacity is to be adapted, by the choice of suitable materials, to the loads resulting during practical use.

A further example of a multi-part piston for an internal-combustion engine is disclosed in German patent document DE 102 44 513 A1. This piston has a piston head part which is forged from steel and into which a combustion cavity, an annular wall and a cooling channel (formed in the manner of a flute) are formed. The piston has a piston skirt part which carries a piston head part and in which hubs are formed for receiving a piston bolt connecting the piston to a connecting rod. For the manufacture of this piston, the piston head part and the piston skirt part are pre-produced in separate operations by forging and then finished by metal cutting. The finishing of the piston head part includes, in this case, the metal-cutting machining of the wall portions which delimit the cooling channel and via which a connection, uniting materials by welding or soldering, to the piston skirt part is subsequently produced.

Although a multi-part construction of this type allows complex shaping of the piston formed from two parts, apart from the load-capacity problems resulting from the multi-part construction, the production costs associated therewith are considerable.

One object of the invention is to provide a piston for an internal-combustion engine, which can be manufactured cost-effectively and allows maximum design freedom.

Another object of the invention is to provide a method for manufacturing a piston of this type.

These and other objects and advantages are achieved by the piston according to the invention, which is made up of at least one first part and a second part, one of the two parts forming the piston head and the other part the piston skirt. At the same time, there is arranged in the piston a cooling chamber which is delimited, in accordance with the prior art described at the outset, by material of the first part and material of the second part. In practice the delimitation of the cooling chamber can be realized for example by at least one wall of the first part and at least one wall of the second part.

According to the invention, the two parts of a piston of this type are joined together positively and non-positively via a press fit that is formed by a projection of the one part engaging with a recess in the other part.

The invention now applies the possibility, in general previously known from the field of the manufacture of pistons for internal-combustion engines, of connecting two parts via a press fit to the particular problem of connecting two piston parts which, when the piston is finished, delimit a cooling chamber. Surprisingly, it has been found that even in the case of a piston according to the invention having such a composition, a permanently rigid, positive and non-positive connection between the piston head and piston skirt part can be ensured.

The fundamental advantage of a piston according to the invention is that the form of the connection of the two piston parts, selected in accordance with the invention, not only can be produced cost-effectively, but also allows maximum design freedom. In particular, it is readily possible, in the manner according to the invention, to form even cooling chambers of complex shape in the piston. Both the piston head part and the piston skirt part can be pre-produced with high precision, so finishing costs are reduced to a minimum.

A further important advantage of the invention lies in the simple possibility of being able to combine even the most diverse materials without difficulty. The invention thus allows, for example, the piston head part to be made of a high-strength stainless steel and the piston skirt part to be made of a steel that is less strong but is particularly deformable or has particularly good sliding properties. It is also possible to combine a piston head part made of steel (in particular stainless steel) with a piston skirt part made of light metal, such as aluminum.

The connection of the two piston parts, produced in accordance with the invention via at least one press fit, also allows the press fit to be formed in each case at the location at which it has an optimum effect with regard to the loads occurring during practical operation. The press fit can thus be formed, for example, in the region of the piston wall forming the outer delimitation of the cooling chamber. A press fit of this type, arranged peripherally in the region of the circumference of the piston, reliably minimizes the risk of opening of the joint seam, which is inevitably present between the first and the second part of a piston according to the invention.

Alternatively or additionally, it can also be expedient to form the press fit in a centrally arranged region of the piston. In this embodiment, the comparatively high thicknesses of the walls present in the central region of the piston allow particularly high pressures to be generated between the molded elements of the piston skirt and piston head part, via which the positive and non-positive connection according to the invention is produced. A particularly operationally secure connection of the two parts of a piston according to the invention is obtained, in this case, if the central pressed fit and the peripheral, outer press fit are combined with each other.

The at least one cooling chamber of the piston according to the invention can be a single integral cooling chamber formed in the center of the piston or a cooling channel which surrounds the center of the piston. It is also possible to combine a first cooling chamber placed in the center of the piston and a second cooling chamber in the form of a channel surrounding the central cooling chamber. By the presence of a centrally placed cooling chamber the transfer of heat from the combustion chamber of the engine to the piston skirt is interrupted, or at least decisively limited, so that the surface temperature of the combustion cavity of the piston rises. Accordingly, the combustion of fuel in the combustion chamber of the engine takes place at high temperatures, so that the chemical energy of the fuel can be used with a higher efficiency.

In principle, it is possible to configure a plurality of cooling chambers in the piston head part or in the piston skirt part of a piston according to the invention in order to achieve maximum cooling effect. If the press fit is formed in the central region of the piston, it is particularly possible to guide a cooling chamber formed as a cooling channel of maximum cross section around the central region. If a press fit between the two parts is additionally formed in the outer peripheral region of the piston, the permanent tightness of the press fit can be reliably ensured.

A simple press fit between the first and second part can be provided by forming into the side of the one part that is associated with the other part, as a recess, a peripheral groove in which, as a projection, a likewise peripheral shoulder of the second part is held positively and non-positively in a press fit.

Particularly secure cohesion between the at least two parts of a piston according to the invention can be achieved by forming in the region of the recess in the one part an undercut with which a corresponding molded element of the projection of the second part engages. The undercut of the recess and the corresponding molded element of the projection are, in this case, to be mutually adapted in such a way that the change in size (caused, for example, by heating of the part provided with the recess and/or cooling of the part provided with the projection) of at least one of the parts is sufficiently great that the projection, despite its molded element associated with the undercut, can be inserted into the recess substantially without force. After the subsequent adaptation of the temperatures of both parts and the accompanying adaptation of the dimensions of both parts, the molded element of the one part then engages with the undercut of the other part and additionally supports the positive connection of both parts.

Practical tests have revealed that the undercut formed in the region of the recess in the first part is for this purpose to have a contact face for the complementarily shaped molded element of the projection, which contact face is inclined by >0° to 5° relative to the direction in which the projection is guided on fitting of the first part into the second part.

In order, for example, to form the peripherally arranged press fit in the region of the circumference of the piston, the recess in the one part can be configured as a peripheral shoulder with which a correspondingly shaped shoulder of the second part engages as a projection.

Although it is in principle possible to provide for this purpose an additional constructional element, likewise connected in the manner in accordance with the invention to the other parts of a piston according to the invention, a particularly practical embodiment of the invention can be produced cost-effectively if a bearing eyelet for a connecting rod bearing is configured on the part of a piston according to the invention that forms the piston skirt.

The possibility of pre-machining as completely as possible the piston skirt part and the piston head part of a piston according to the invention for internal-combustion engines allows the piston to be manufactured in a particularly simple manner. The method according to the invention accordingly provides for a recess to be formed on the first part and a projection to be formed on the second part during the pre-production of the first part, with the dimensions of the recess in the one part and of the projection of the other part being mutually adapted in such a way that they can be joined together at room temperature only by means of a press fit. There are also formed into the two parts, during the course of the pre-production process, the molded elements such as, for example, suitably shaped grooves, recesses, etc., which delimit the respective cooling chamber when the piston according to the invention is fully assembled.

After pre-production, in accordance with the generally conventional procedure for the production of a press-fit, the temperature of at least one of the parts is adjusted such that there is a difference in temperature between the first and the second part, which is sufficiently large that at least one of the parts changes its shape so that the projection of the one part can be fitted substantially without force into the recess in the other part. The projection of the one part can then be fitted into the recess in the other part. After the temperatures of the two parts are subsequently equalized, they are positively and/or non-positively linked to each other via the pairing “recess in the one part”/“projection of the other part”.

Depending on the thermal expansion properties of each part, it can be beneficial for the first part provided with the recess to be heated for producing the difference in temperature. For this purpose, the respective first part can, for example, be heated to a heating temperature of 100 to 700° C. Practical tests have revealed in this regard that, regardless of the size of each part and the heat source available, a heating period of 5 to 3,600 s is required for this purpose.

However, alternatively or additionally, it can also be expedient, in a manner known per se, to cool the part provided with the projection for producing the difference in temperature.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic, partially cut-open perspective view of a piston for an internal-combustion engine;

FIG. 2 is a schematic longitudinal section of a detail of the piston shown in FIG. 1;

FIG. 3 is a schematic longitudinal section of a detail of a second piston;

FIG. 4 is a schematic longitudinal section of a detail of a third piston;

FIG. 5 is a schematic, partially cut-open perspective view of fourth piston for an internal-combustion engine; and

FIG. 6 is a schematic, partially cut-open perspective view of a fifth piston for an internal-combustion engine.

### DETAILED DESCRIPTION OF THE INVENTION

The pistons 1 to 3 shown in the figures are each of two-part construction, including a piston head part 4, 5, 6 and a piston skirt part 7, 8, 9. The piston head parts 4, 5, 6 are formed of a high- strength steel, such as stainless steel, whereas the piston skirt parts 7, 8, 9 can be made of a steel that is less strong but is highly deformable, or of a light material, such as aluminum.

The piston head parts 4, 5, 6 and the piston skirt parts 7, 8, 9 have each been pre-produced by forging. During the pre-production process, there is formed into the underside of the piston head parts 4, 5, 6, associated with the respective piston skirt part 7, 8, 9, an annular depression 10, 11, 12 in the form of a groove that encircles the central region 13 of the respective piston head part 4, 5, 6. A combustion cavity 14, 15, 16, which is configured in a manner known per se, is also formed at the free upper side of the piston head parts 4, 5, 6.

In the upper side of the respective piston skirt parts 7, 8, 9, associated with the respective piston head part 4, 5, 6, is an annular depression 17, 18, 19 in the form of a groove that encircles the central region of the respective piston skirt part 7, 8, 9. The depression 17, 18, 19 are in this case arranged in such a way that they form in conjunction with the indentations 10, 11, 12 associated therewith, when the piston 1, 2, 3 is fully assembled, a peripheral cooling chamber in the form of a cooling channel 20, 21, 22 which is delimited in its upper region by material of the respective piston head part 4, 5, 6 and in its lower region by material of the respective piston skirt part 7, 8, 9.

In the lower region of each of the piston skirt parts 6, 7, 8, there is formed (in a manner known per se) a respective bearing eyelet 23 for a bolt (not shown) via which a connecting rod (which is also not shown) is articulated to the respective piston 1, 2, 3.

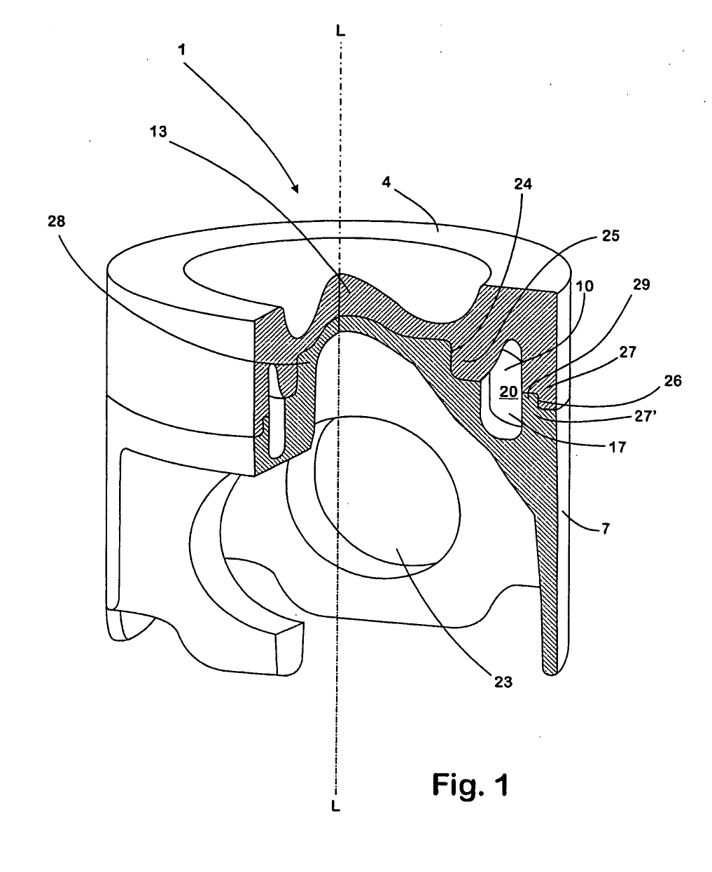

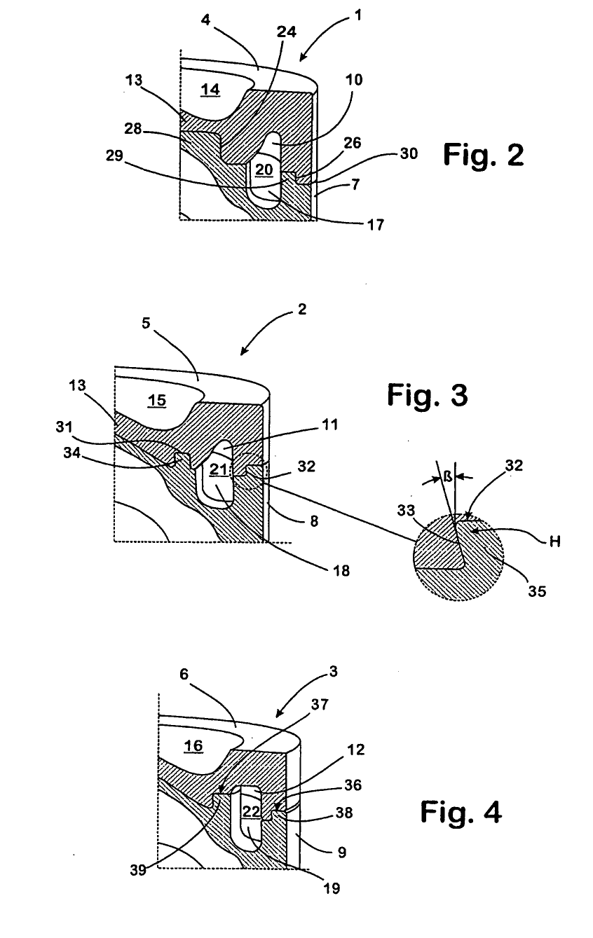

In the embodiment shown in FIGS. 1 and 2, there is formed into the central region 13 of the piston head part 4, from the underside thereof, a centrally arranged recess 24, the opening of which is oriented normally to the longitudinal axis L of the piston 4 and is separated from the depression 10 in the piston head part 4 by a peripheral shoulder 25.

In the piston 1, a second recess 26, in the form of a shoulder that encircles in the outer edge region of the piston head part 4, is formed on the inner edge of the wall 27, outwardly delimiting the indentation 10, of the piston head part 4.

In the piston 1, corresponding to the centrally arranged recess 24 in the piston head part 4, a projection 28 is formed integrally with the upper side of the piston skirt part 7, associated with the piston head part. In the pre-produced state (not assembled with the piston head part 4), the external diameter of the projection 28 is larger by an excess amount than the internal diameter of the recess 24. This excess amount is such that, on the one hand, the expansion of the recess 24 accompanying in the radial direction heating of the piston head part 4 is sufficient to allow the projection 28 to be introduced into the recess 24 substantially without force and, on the other hand, the surface pressure achieved between the external circumferential surface of the projection 28 and the internal circumferential surface of the recess 24 after the assembly and cooling of the two parts 1, 4 is sufficient for reliable and permanent connection of the piston head part 4 to the piston skirt part 7.

In addition, a likewise annularly peripheral projection 29, configured as a shoulder, is formed on the upper side of the piston skirt part 7, associated with the piston head part 4, in the wall 27′ outwardly delimiting the indentation 17, of the piston skirt part 7 so as to correspond to the peripheral recess 26, formed as a shoulder, in the piston head part 4. In the pre-produced but not yet assembled state, the outer circumferential wall of the projection 29 is oriented so as to be offset by an excess amount, based on the common longitudinal axis L of the piston 1, relative to the internal circumferential surface of the shoulder-like recess 26 in the piston head part 4. As in the case of the projection 28, this excess is such that, on the one hand, the expansion of the recess 26 in the radial direction due to heating of the piston head part 4 is sufficient to allow the projection 29 to be introduced into the recess 26 substantially without force and, on the other hand, the surface pressure achieved between the external circumferential surface of the projection 29 and the internal circumferential surface of the recess 26 after the assembly and cooling of the two parts 1, 4 is sufficient to prevent opening of the seam 30 inevitably present between the piston head part 4 and the piston skirt part 7.

In the piston 2 (FIG. 3), a recess 31 in the form of a groove encircling the central region 13 of the piston head part 5, is formed into the central region 13 of the piston head part 5, from the underside thereof associated with the piston skirt part 8. In addition, a further recess 32, in the form of a shoulder encircling the outer lower edge of the piston head part 5, is formed on the piston head part 5 of the piston 2. The circumferential surface 33 of the recess 32 is in this case inclined by an angle β of approx. 2° relative to the longitudinal axis L of the piston 3 toward the underside of the piston head part 5, so an undercut H is formed in the region of the recess 32.

Corresponding to the recess 31, formed as a groove in the piston head part 5, a first shoulder-like peripheral projection 34 is formed integrally with the upper side of the piston skirt part 8, associated with the piston head part 5. In addition, a projection 35, corresponding to the recess 32, formed as a shoulder and encircling the circumference of the piston skirt part 9, is formed on the outer edge of the upper side of the piston skirt part 8, associated with the piston head part 5. The internal circumferential surface of the projection 35 is in this case inclined, so as to correspond to the circumferential surface 33 of the recess 32, relative to the longitudinal axis L by an angle of approx. 2°.

The position and dimensions of the recesses 31, 32 and the projections 34, 35 are, in each case, such that the projections 34, 35 of the piston skirt part 8 can, after appropriate temperature adjustment, be introduced into the recesses 31, 32 in the piston head part 5. After the temperatures of the piston skirt part 8 and piston head part 5 are equalized, there is then between the circumferential surfaces of the recesses 31, 32 and the adjacent faces of the projections 34, 35 a surface pressure which is sufficient reliably to hold together the two parts 5, 9 of the piston 5 even during practical use. The connection formed in the region of the pairing “recess 31” and “projection 35” by the undercut and the internal circumferential surface, engaging therewith, of the projection 35 additionally supports this cohesion.

In the piston 3, (FIG. 4) a recess 36, in the form of a shoulder encircling the outer lower edge of the piston head part 6, is formed on the piston head part 6, in the same manner as in the piston head part 5 of the piston 2. In addition, on the inner upper edge of the depression 12, a further recess 37, in the form of a peripheral shoulder, is formed into the piston head part 6.

Projections 38, 39, encircling in the manner of shoulders, are configured on the upper side of the piston skirt part 9, associated with the piston head part 6, corresponding to the recesses 36, 37 in the piston skirt part 9. The position and dimensions of the projections are in this case also selected in such a way that the piston head part 6 and the piston skirt part 9 cannot be joined together in the pre-produced state at room temperature; instead, for this purpose, at least the piston head part 6 has to be cooled sufficiently or the piston skirt part 9 has to be heated sufficiently, so that the resulting change in dimensions, of each part 6, 9 is sufficient to allow it to be joined to the respective other part 9, 6 substantially without force.

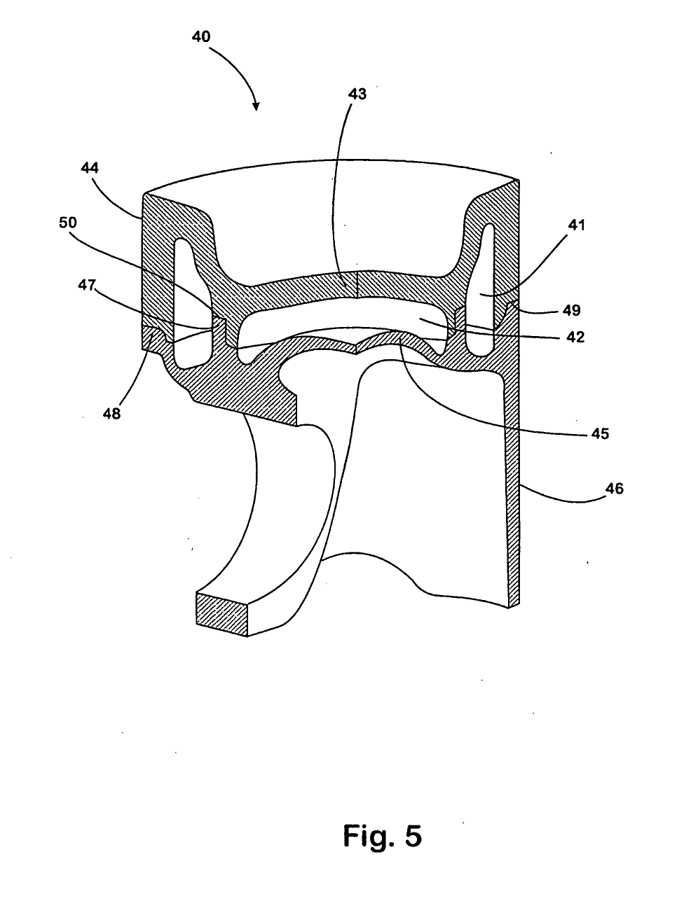

Piston 40 shown in FIG. 5 has a cooling channel 41 formed and positioned similar to the cooling channel 21 of piston 2. Additionally a cooling chamber 42 is formed in the central region of the piston 40 between the wall section 43 in which the combustion cavity of the piston head part 44 is molded and the wall section 45 forming the top of the piston skirt part 46 of piston 40.

The positive and non-positive connection between the piston head part 44 and the piston skirt part 46 is realized in the same manner as the connection between the piston head part 5 and the piston skirt part 8 of the piston 2 shown in FIG. 3. Accordingly, from the skirt part 46 of piston 40 projections 47 and 48 shaped and positioned as the projections 34 and 35 of the piston skirt part 8 of piston 2 engage corresponding recesses 49 and 50 formed in the piston head part 44 of piston 40.

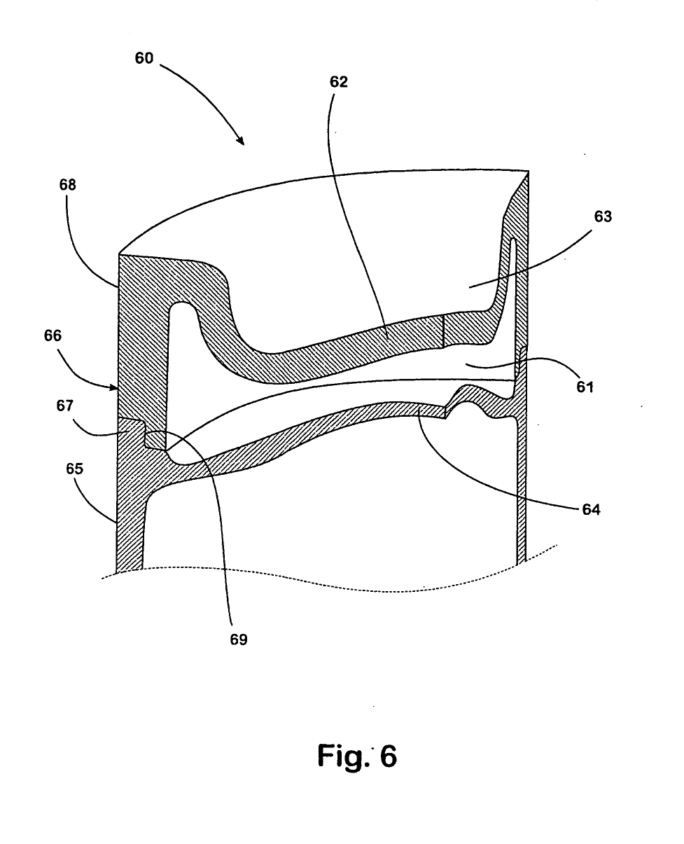

Piston 60 shown in FIG. 6 has one single cooling chamber 61 formed between the wall section 62 into which the combustion cavity 63 of the piston 60 is molded and the wall section 64 which forms the top of the piston skirt part 65 of piston 60. This cooling chamber extends inside the outer wall 66 of the piston 60. Accordingly, the piston head part 68 the piston 60 is connected with the piston skirt part 65 only by a projection 68 of the outer wall part of the piston skirt part 65 extending into a recess correspondingly formed in the outer wall part of the piston head part 44. The positive and non-positive connection between the projection 68 of the skirt part 64 and the recess 69 of the head part 66 is formed in the same manner as the connection between the projection 29 of the piston skirt part 7 and the recess 26 of the piston head part 4 of the piston 1 shown in FIG. 1.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE NUMERALS

1, 2, 3 Piston
4, 5, 6 Piston head part
7, 8, 9 Piston skirt part
10, 11, 12 Depression
13 Central region of the piston head part 4, 5, 6
14, 15, 16 Combustion cavity
17, 18, 19 Depression
20, 21, 22 Cooling channel
23 Bearing eyelet
24 Recess in the piston head part 4
25 Shoulder of the piston head part 4
26 Recess in the piston head part 4
27 Wall of the piston head part 4#
28 Projection
29 Projection
30 Seam
31 Recess
32 Recess
33 Circumferential surface of the recess 32
34 Projection
35 Projection
36 Recess
37 Recess
38 Projection
39 Projection
40 Piston
41 Cooling channel
42 Cooling chamber
43 Wall section
44 Piston head part of piston 40
45 Wall section
46 Piston skirt part of piston 40
47,48 Projections
49,50 Recesses
60 Piston
61 Cooling chamber
62 Wall section
63 Combustion cavity of the piston 60
64 Wall section
65 Piston skirt part
66 Outer wall of the piston 60
67 Piston head part of the piston 60
68 Projection
69 Recess
β Angle
H Undercut
L Longitudinal axis L of the pistons 4, 5, 6

1.-34. (canceled)

34. A piston for an internal-combustion engine, said piston comprising a first part and a second part; wherein:
one of said first and second parts forms a piston head and the other forms a piston skirt;
a cooling chamber, which is delimited by material of the first and second parts, is configured in the piston;
the first and second parts are joined together positively and non-positively via a press fit formed by the projection of the second part, which projection engages with a recess in the first part;
a first press fit is formed in a region of the piston wall that forms an outer delimitation of the cooling chamber;
a second press fit is formed in a centrally situated region of the piston; and
the cooling chamber extends around the central region in which the first press fit is produced.

36. The piston according to claim 35, wherein:
a peripheral groove is formed as a recess into the side of one of said parts; and
a peripheral shoulder of the second part is formed as a projection in the peripheral groove, and held positively and non-positively in a press fit.

37. The piston according to claim 35, wherein an undercut with which a corresponding moulded element of the projection of the other of said parts engages is formed in the region of the recess in said one of said parts.

38. The piston according to claim 37, wherein said undercut has a contact face for a complementarily shaped moulded element of the projection, which contact face is inclined by >0° to 5° relative to a direction in which the projection is guided on fitting of the first part into the second part.

39. The piston according to claim 35, wherein said recess in one of said parts is configured as a peripheral shoulder with which a correspondingly shaped shoulder of the other of said parts engages as a projection to produce the press fit.

40. The piston according to claim 35, wherein a bearing eyelet for a connecting rod bearing is configured on the part forming the piston skirt.

41. The piston according to claim 35, wherein the part that forms the piston head is made of a steel, and the other part is made of a light metal.

42. The piston according to claim 35, wherein the cooling chamber comprises a cooling channel.

43. A method for manufacturing a piston according to claim 35, said method comprising:
forming a first part, with a recess therein;
forming a second part with a projection configured thereon, the dimensions of the recess in the first part and of the projection of the other part being mutually configured such that they can be joined together at room temperature only by means of a press fit;
producing a difference in temperature between the first and second parts, such that at least one of the parts changes its shape as a result of the change in its temperature accompanying the production of the difference in temperature, whereby the projection of the first part can be fitted substantially without force into the recess in the second part;
fitting the projection of the first part into the recess in the second part; and
equalizing the temperature of the first part to the temperature of the second part, so the two parts are positively and/or non-positively linked to each other via mating of the recess in the first part with the projection of the second part.

44. The method according to claim 43, wherein the first part is heated to produce the difference in temperature.
